(19) United States
(12) Patent Application Publication
(10) Pub. No.: US 2020/0187040 A1
(43) Pub. Date: Jun. 11, 2020

(54) CENTRALIZED MANAGEMENT NODE, DISTRIBUTED NODE, AND METHOD FOR PACKET DELAY CONTROL

(71) Applicant: Industrial Technology Research Institute, Hsinchu (TW)

(72) Inventors: Tzu-Jane Tsai, Hsinchu County (TW); Chun-Yuan Chiu, Pingtung County (TW)

(73) Assignee: Industrial Technology Research Institute, Hsinchu (TW)

(21) Appl. No.: 16/703,860

(22) Filed: Dec. 5, 2019

Related U.S. Application Data
(60) Provisional application No. 62/775,923, filed on Dec. 6, 2018.

(51) Int. Cl. H04W 28/02; H04W 24/10

(52) U.S. Cl. CPC H04W 28/0236; H04W 24/10; H04W 84/047; H04W 28/0284; H04W 28/0263

(57) ABSTRACT

A centralized management node, a distributed node, and a method for packet delay control are provided. In the method, the centralized management node receives measurement data related to packet delay for each of a plurality of first communication channels from at least one node subsidiary to the centralized management node. The centralized management node assigns a packet delay budget (PDB) information to a data radio bearer (DRB) per hop of at least one user equipment (UE).

### CROSS-REFERENCE TO RELATED APPLICATION

This application claims the priority benefit of U.S. provisional application Ser. No. 62/775,923, filed on Dec. 6, 2018. The entirety of the above-mentioned patent application is hereby incorporated by reference herein and made a part of this specification.

### BACKGROUND

### Technical Field

The disclosure relates to a centralized management node, a distributed node, and a method for packet delay control.

### Description of Related Art

Currently in Fifth Generation (5G) new radio (NR), the millimeter wave (mmWave) spectrum is used. Since the 5G NR communication system has an available bandwidth larger than that of the Long-Term Evolution (LTE) communication system and is coupled with new deployment of massive multi-input multi-output (MIMO) or multi-beam communication system, there will be opportunities to develop and deploy integrated access and backhaul (IAB) links.

In recent years, under the 5G NR communication system, the most commonly discussed issue is about IAB network architecture. In a general single-hop environment, the packet delay budget (PDB) can be described as an upper bound for the time that a packet may be delayed between user equipment (UE) and user plane function (UPF), and is used to support the configuration of scheduling and link layer function. However, in a multi-hop environment, it has not been detailed how to control the PDB between the UE and the UPB.

### SUMMARY

The disclosure provides a packet delay control method for a centralized management node. The method includes following steps: receiving measurement data related to packet delay for each of a plurality of first communication channels from at least one node subsidiary to the centralized management node; and assigning a packet delay budget (PDB) information to a data radio bearer (DRB) per hop of at least one user equipment (UE).

The disclosure provides a packet delay control method for a distributed node. The method includes following steps: measuring measurement data related to packet delay for each of a plurality of first communication channels and reporting the measurement data to a centralized management node; and receiving a PDB information assigned by the centralized management node.

The disclosure provides a centralized management node including a communication interface and a processor. The communication interface communicates with an at least one node subsidiary to the centralized management node. The processor is coupled to the communication interface and configured to execute instructions to receive measurement data related to packet delay for each of a plurality of first communication channels from at least one node subsidiary to the centralized management node, and assign a PDB information to a DRB per hop of at least one UE.

The disclosure provides a distributed node including a communication interface and a processor. The communication interface communicates with a centralized management node. The processor is coupled to the communication interface and configured to execute instructions to measure measurement data related to packet delay for each of a plurality of first communication channels and reporting the measurement data to a centralized management node, and receive a PDB information assigned by the centralized management node.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of wireless multi-hop network system in a 5G NR communication system according to an embodiment of the disclosure.

FIG. 2 is a block diagram illustrating structures of a distributed node and a centralized management node according to an embodiment of the disclosure.

FIG. 3 is a flowchart illustrating a packet delay control method according to an embodiment of the disclosure.

FIG. 4 is schematic diagrams illustrating a packet delay control method according to an embodiment of the disclosure.

FIG. 5 is a flowchart illustrating another packet delay control method according to an embodiment of the disclosure.

FIG. 6 is schematic diagrams illustrating a packet delay control method according to an embodiment of the disclosure.

FIG. 7A and FIG. 7B are schematic diagrams of an example of modifying bearer mapping in a wireless multi-hop network system according to an embodiment of the disclosure.

FIG. 8A and FIG. 8B are schematic diagrams of an example of modifying bearer mapping in a wireless multi-hop network system according to an embodiment of the disclosure.

FIG. 9A and FIG. 9B are schematic diagrams of an example of modifying bearer mapping in a wireless multi-hop network system according to an embodiment of the disclosure.

FIG. 10A and FIG. 10B are schematic diagrams of an example of modifying bearer mapping in a wireless multi-hop network system according to an embodiment of the disclosure.

### DESCRIPTION OF THE EMBODIMENTS

In the present disclosure, exemplary embodiments of a multi-hop packet delay budget (PDB) assignment in an integrated access and backhaul (IAB) network are provided to avoid additional overhead. In some embodiments, an IAB donor may decide configuration of PDB values and bearer mapping, and in other embodiments, an IAB node may decide the bearer mapping by itself. In this way, scheduling implementation of PDB for general single-hop environment may be reused in multi-hop environment.

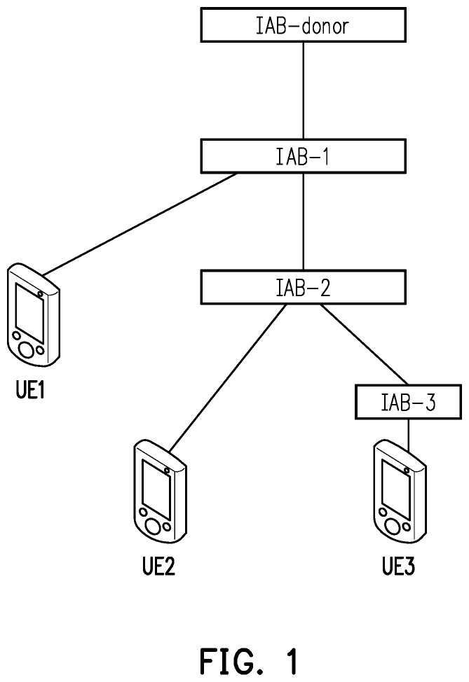

For example, FIG. 1 is a schematic diagram of wireless multi-hop network system in a Fifth Generation (5G) new radio (NR) communication system according to an embodiment of the disclosure. Referring to FIG. 1, a wireless multi-hop network system of the present embodiment comprises a centralized management node IAB-donor and a plurality of distributed nodes IAB-1˜IAB-3 which are connected to one another through backhaul links in a wired or wireless manner, wherein the centralized management node IAB-donor could be an IAB donor and each of the distributed nodes IAB-1˜IAB-3 could be an IAB node in a general IAB network. The distributed nodes IAB-1˜IAB-3 may provide wireless accesses for a plurality of user equipment (UEs) UE1˜UE3 respectively, wherein the UEs UE1˜UE3 may be a stationary or mobile communication device supporting 5G NR such as a mobile station, a server, a personal computer (PC), a tablet PC, a phone device, a personal digital assistant (PDA) and the like. It is worth noting that the number of distributed nodes may be any positive integer and the number of UEs also may be any positive integer, which are not limited herein.

Furthermore, the delay between a user plane function (UPF) and the centralized management node IAB-donor is fixed and assumed to be Oms in this exemplary embodiment. The centralized management node IAB-donor may receive information from a core network via a wired or wireless interface and deliver such information to the distributed nodes IAB-1˜IAB-3 through the respective backhaul link so that each distributed node may provide accesses for one or more UEs.

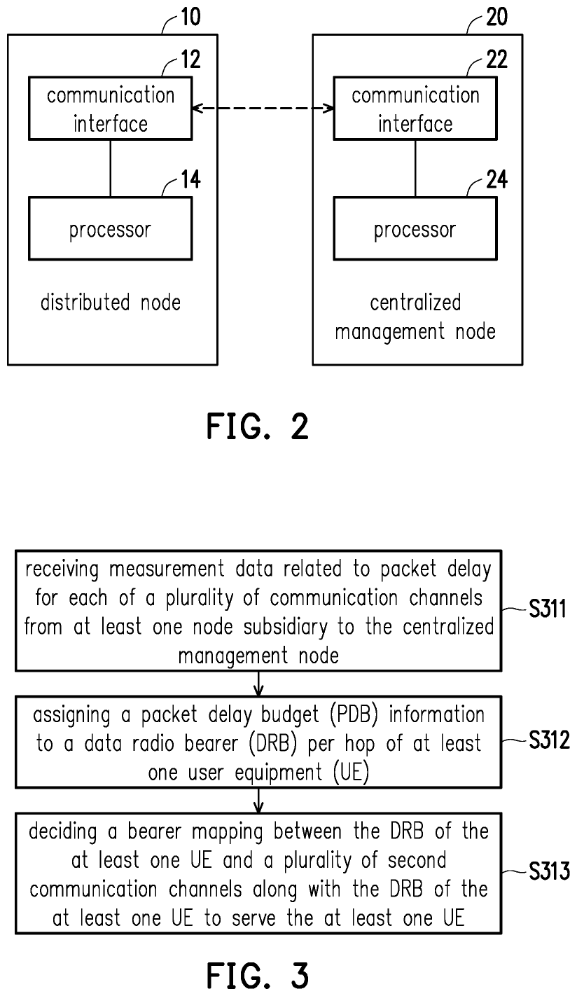

FIG. 2 is a block diagram illustrating structures of a distributed node and a centralized management node according to an embodiment of the disclosure. Referring to FIG. 2, the distributed node 10 and the centralized management node 20 may be a next generation node B (gNodeB or gNB), wherein the distributed node 10 and the centralized management node 20 are equivalent to the centralized management node IAB-donor and the distributed nodes IAB-1˜IAB-3 in FIG. 1, respectively. The distributed node 10 at least includes a communication interface 12 and a processor 14. The communication interface 12 is, for example, configured to communicate with neighbor nodes of the distributed node 10 such as the centralized management node 20, other distributed nodes or neighbor UEs (e.g. the UEs UE1˜UE3 in FIG. 1). The processor 14 is, for example, a programmable calculation device, such as a microprocessor, a microcontroller, a central processing unit (CPU), a digital signal processor (DSP), a field programmable gate array (FPGA), an application-specific integrated circuit (ASIC) or the like, and is coupled to the communication interface 12 and configured to control the operations of the distributed node 10.

The centralized management node 20 at least includes a communication interface 22 and a processor 24. The communication interface 22 is, for example, configured to communicate with the communication interface 12 in the distributed node 10. The processor 24 is, for example, a programmable calculation unit, such as a microprocessor, a microcontroller, a CPU, a DSP, a FPGA, an ASIC or the like, and is coupled to the communication interface 22 and configured to control the operations of the centralized management node 20.

FIG. 3 is a flowchart illustrating a packet delay control method according to an embodiment of the disclosure. Referring to FIG. 3, the method of the present embodiment is adapted to the centralized management node such as the centralized management node IAB-donor as described in aforementioned embodiment. Detailed steps of the method are described below with reference to the distributed nodes IAB-1˜IAB-3, the centralized management IAB-donor and the UEs UE1˜UE3 of FIG. 1. For convenience of description of the following the embodiment, it is assumed that the centralized management IAB-donor has acquired the whole topology and routing of its descendant distributed nodes IAB-1˜IAB-3 and stores data radio bearers (DRBs) of the UEs UE1˜UE3 beforehand, and the centralized management IAB-donor and the distributed nodes IAB-1˜IAB-3 store information about all existing communication channels.

First, in step S311, the centralized management node IAB-donor receives measurement data related to packet delay for each of a plurality of communication channels from at least one node (i.e. the distributed node IAB-1˜IAB-3 and the UEs UE1˜UE3 subsidiary to the distributed nodes IAB-1˜IAB-3, respectively) subsidiary to the centralized management node IAB-donor. There are a plurality of communication channels between the centralized management node IAB-donor and the UEs UE1˜UE3, and the number of the communication channels is not limited herein. For example, there may be two communication channels between the centralized management node IAB-donor and the UE UE1. The measurement data may include information such as one or a combination of congestion level information, uplink delay information and downlink delay information corresponding to the plurality of communication channels. The uplink delay and the downlink delay belong to the backhaul adaptation protocol (BAP) packet delay, wherein the uplink delay includes scheduling delay and transmission delay, and the downlink delay includes queueing delay. In addition, the communication channels may be radio link control (RLC) channels.

Further, the UE UE1 may periodically detect the communication channel between the distributed node IAB-1 and itself to measure the measurement data. In some embodiments, the UE UE1 may be triggered to measure the measurement data according to an event such as the UE UE1 is congested or one UE UE1's uplink communication channel is congested. Similarly, the distributed nodes IAB-1˜IAB-3 and the UEs UE2˜UE3 may measure the measurement data in the same way. Afterwards, the distributed nodes IAB-1˜IAB-3 and the UEs UE1˜UE3 may send the measurement data to the centralized management node IAB-donor.

In one embodiment, after step S311, the centralized management node IAB-donor may determine whether the PDB information corresponding to at least one of the plurality of communication channels is required to be created or modified according to the measurement data, so as to assign the PDB information per hop to each of the at least one node if the PDB information is required to be created or modified. In other words, if the PDB information is required to be created or modified, the flow will proceed to step S312. On the contrary, if the PDB information is not required to be created or modified, the flow will proceed to step S311. In detail, according to the measurement data, the centralized management node IAB-donor may determine whether at least one of the distributed nodes IAB-1˜IAB-3 and the UEs UE1˜UE3 makes handover and whether there is a congestion occurred at the communication channels between the distributed nodes IAB-1˜IAB-3 and the UEs UE1˜UE3 and a congestion occurred at the distributed nodes IAB-1˜IAB-3 and the UEs UE1˜UE3. If yes, the centralized management node IAB-donor may determine that the PDB information is required to be created or modified.

In another embodiment, the centralized management node IAB-donor may select at least one communication channel from a plurality of existing communication channels or creating at least one new communication channel, and decide the PDB information per hop according to the PDB sums of DRB of the at least one UE, wherein selected communication channels or created communication channels will be matched to DRBs of the UEs UE1˜UE3.

Then, in step S312, the centralized management node IAB-donor assigns PDB information to the DRB per hop of at least one UE. In one embodiment, the centralized management node IAB-donor assigns PDB information per hop to each of the at least one node. In detail, the centralized management node IAB-donor may decide the PDB information per hop according to PDB sums of the DRB of the at least one UE (i.e. the UEs UE1˜UE3), and send the decided PDB information per hop to each of the distributed nodes IAB-1˜IAB-3.

For example, it is assumed that the PDB sum of the DRB of the UE UE1 is 10, the PDB sum of the DRB of the UE UE2 is 20, and the PDB sum of the DRB of the UE UE3 is 50. The centralized management node IAB-donor may decide and assign a PDB value of 5 to the DRB of the UE UE1 between the centralized management node IAB-donor and the distributed node IAB-1, the DRB of the UE UE1 between the distributed node IAB-1 and the UE UE1, the DRB of the UE UE2 between the centralized management node IAB-donor and the distributed node IAB-1, and the DRB of the UE UE2 between the distributed node IAB-2 and the UE UE2. The centralized management node IAB-donor may decide and assign a PDB value of 10 to the DRB of the UE UE2 between the distributed nodes IAB-1 and IAB-2, the DRB of the UE UE3 between the distributed nodes IAB-2 and IAB-3, and the DRB of the UE UE3 between the distributed node IAB-3 and the UE UE3. The centralized management node IAB-donor may decide and assign a PDB value of 15 to the DRB of the UE UE3 between the centralized management node IAB-donor and the distributed nodes IAB-1, and the DRB of the UE UE3 between the distributed nodes IAB-1 and IAB-2.

Finally, in step S313, the centralized management node IAB-donor decides a bearer mapping between a DRB of at least one UE and the plurality of communication channels along with the DRB of the at least one UE to serve the at least one UE, wherein the plurality of communication channels along with the DRB of the at least one UE are selected from the plurality of communication channels corresponding to the at least one node subsidiary to centralized management node IAB-donor by the centralized management node IAB-donor. In one embodiment, the centralized management node IAB-donor may send the PDB information corresponding to each node and the bearer mapping corresponding to each node to each node respectively. Therefore, a table which includes the PDB information and the bearer mapping corresponding to each node is stored at each node. For example, Table 1 lists the information stored in the distributed node IAB-1 described above.

TABLE 1

| | | | |
|---|---|---|---|
| NextHopID | UE1 | IAB-2 | IAB-2 |
| PriorHopID | IAB-donor | IAB-donor | IAB-donor |
| ingress | Channel #1 | Channel #1 | Channel #2 |
| Communication | with PDB 5 | with PDB 5 | with PDB 15 |
| channel | | | |
| egress | Channel #1 | Channel #2 | Channel #3 |
| Communication | with PDB 5 | with PDB 10 | with PDB 15 |
| channel | | | |

To be specific, in one embodiment, the centralized management node IAB-donor may select at least one communication channels from a plurality of existing communication channels according to the PDB information, or creates at least one new communication channel according to the PDB information.

For example, in case that the centralized management node IAB-donor has stored information about three communication channels, wherein the PDB value of first communication channel is 5, the PDB value of second communication channel is 10, and the PDB value of third communication channel is 15, the centralized management node IAB-donor may map a first communication channel to the DRB of the UE UE1 between the centralized management node IAB-donor and the distributed node IAB-1, the DRB of the UE UE1 between the distributed node IAB-1 and the UE UE1, the DRB of the UE UE2 between the centralized management node IAB-donor and the distributed node IAB-1, and the DRB of the UE UE2 between the distributed node IAB-2 and the UE UE2. The centralized management node IAB-donor may map a second communication channel to the DRB of the UE UE2 between the distributed nodes IAB-1 and IAB-2, the DRB of the UE UE3 between the distributed nodes IAB-2 and IAB-3, and the DRB of the UE UE3 between the distributed node IAB-3 and the UE UE3. The centralized management node IAB-donor may map a third communication channel to the DRB of the UE UE3 between the centralized management node IAB-donor and the distributed node IAB-1, and the DRB of the UE UE3 between the distributed nodes IAB-1 and IAB-2.

Further, if the PDB value of the DRB of the UE UE1 between the centralized management node IAB-donor and the distributed node IAB-1 is changed to 2 and the PDB value of the DRB of the UE UE1 between the distributed nodes IAB-1 and IAB-2 is changed to 8, the centralized management node IAB-donor may create a fourth communication channel and a fifth communication channel, wherein the PDB value of the fourth communication channel is 2, and the PDB value of the fifth communication channel is 8. And then, the centralized management node IAB-donor may map the fourth communication channel to the DRB of the UE UE1 between the centralized management node IAB-donor and the distributed node IAB-1, and map the fifth communication channel to the DRB of the UE UE1 between the distributed nodes IAB-1 and IAB-2.

It is noted that, in some embodiments, an order of the steps S312 and S313 may be exchanged. That is, the centralized management node IAB-donor may decide the bearer mapping such as using an existing communication channel or creating a new communication channel for its descendant nodes (i.e. the distributed nodes IAB-1 to IAB-3) first and then decides the PDB information per hop for the DRB of the UEs.

Based on the above, the centralized management node IAB-donor may decide the PDB information and the bearer mapping corresponding to each node according to the measurement data and the existing communication channels. Therefore, scheduling implementation of PDB for general single-hop environment may be reused in multi-hop IAB network. It's unnecessary to design a new PDB mechanism in IAB, so smaller standard impact is made. In addition, existing UE-bearer-specific identification (ID), UE-specific ID, Route ID, IAB-node or IAB-donor address, and quality of service (QoS) information carried in adaptation layer header may be reused, and it's unnecessary to handle the time field in adaptation layer header per packet for delay calculation.

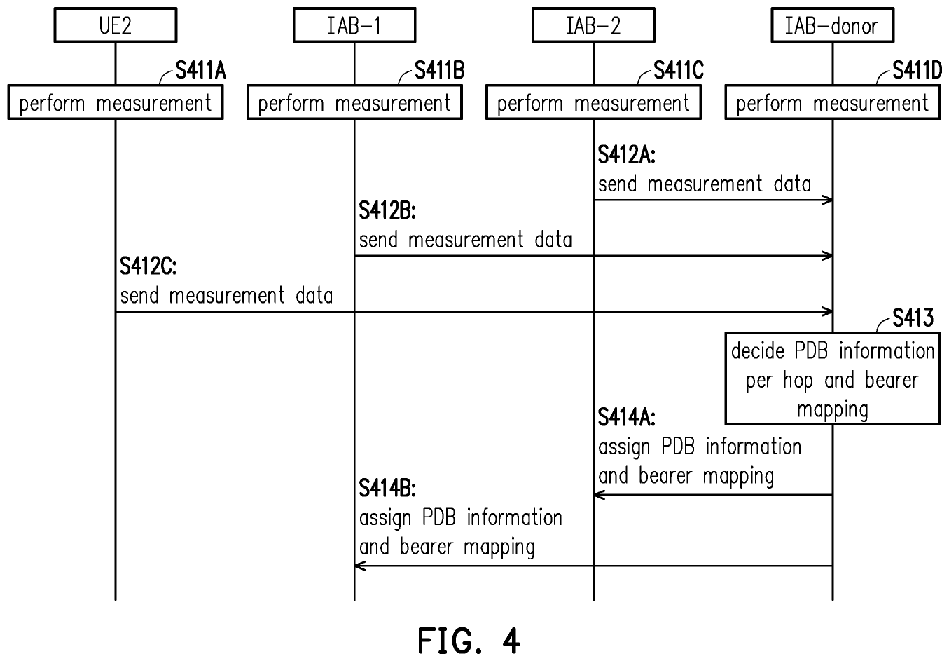

FIG. 4 is schematic diagrams illustrating a packet delay control method according to an embodiment of the disclosure. Detailed steps of the method are described below with reference to the centralized management IAB-donor, the distributed nodes IAB-1˜IAB-2 and the UE UE2 of FIG. 1. The following takes the DRB of the UE2 as an example.

In the embodiments of FIG. 4, the steps of the packet delay control method include:

Steps S411A˜S411D: the centralized management IAB-donor, the distributed nodes IAB-1˜IAB-2 and the UE UE2 perform measurement, respectively. In one embodiment, the centralized management IAB-donor may detect its congestion level and downlink delays of communication channels between the centralized management IAB-donor and the distributed node IAB-1. The distributed node IAB-1 may detect its congestion level, downlink delays of communication channels between the distributed nodes IAB-1 and IAB-2, and uplink delays of communication channels between the centralized management IAB-donor and the distributed node IAB-1. The distributed node IAB-2 may detect its congestion level, downlink delays of communication channels between the distributed node IAB-2 and the UE UE2, and uplink delays of communication channels between the distributed nodes IAB-1 and IAB-2. The UE UE2 may detect an uplink delay of a communication channel between the distributed node IAB-2 and the UE UE2.

Steps S412A˜S412C: the distributed nodes IAB-1˜IAB-2 and the UE UE2 send measurement data to the centralized management IAB-donor respectively. In one embodiment, measurement data may include the congestion level of the distributed node IAB-1, the downlink delays of the communication channels between the distributed nodes IAB-1 and IAB-2, the uplink delays of the communication channels between the centralized management IAB-donor and the distributed node IAB-1, the congestion level of the distributed node IAB-2, the downlink delays of the communication channels between the distributed node IAB-2 and the UE UE2, the uplink delays of the communication channels between the distributed nodes IAB-1 and IAB-2, and the uplink delay of the communication channel between the distributed node IAB-2 and the UE UE2.

Step S413: the centralized management IAB-donor decides PDB information per hop and bearer mapping.

Steps S414A˜S414B: the centralized management IAB-donor assigns the PDB information and bearer mapping to the distributed nodes IAB-1˜IAB-2, respectively, such that the distributed nodes IAB-1˜IAB-2 and the UE UE2 may follow the received PDB information and bearer mapping to perform packet transmission.

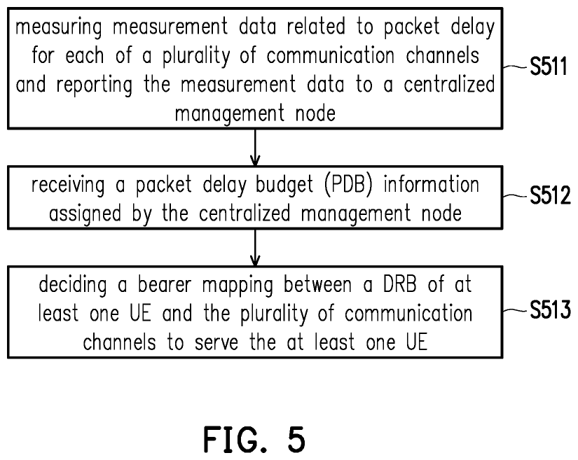

FIG. 5 is a flowchart illustrating another packet delay control method according to an embodiment of the disclosure. Referring to FIG. 5, the method of the present embodiment is adapted to the distributed node such as the distributed nodes IAB-1˜IAB-3 as described in aforementioned embodiment. Detailed steps of the method are described below with reference to the distributed nodes IAB-1˜IAB-3, the centralized management IAB-donor and UEs UE1˜UE3 of FIG. 1. For convenience of description of the following the embodiment, it is assumed that the centralized management IAB-donor has acquired the whole topology and routing of its descendant distributed nodes IAB-1˜IAB-3 and stores DRBs of the UEs UE1˜UE3 beforehand, and the centralized management IAB-donor and the distributed nodes IAB-1˜IAB-3 store information about all existing communication channels.

First, in step S511, the distributed nodes IAB-1˜IAB-3 measure measurement data related to packet delay for each of a plurality of communication channels and reporting the measurement data to the centralized management IAB-donor. There are a plurality of communication channels between the centralized management node IAB-donor and the UEs UE1˜UE3, and the number of the communication channels is not limited herein. The measurement data may include information such as one or a combination of congestion level information, uplink delay information and downlink delay information corresponding to the plurality of communication channels. The uplink delay and the downlink delay belong to the BAP packet delay, wherein the uplink delay includes scheduling delay and transmission delay, and the downlink delay includes queueing delay. In addition, the communication channels may be RLC channels.

Further, the UE UE1 may periodically detect the communication channel between the distributed node IAB-1 and itself to measure the measurement data. Similarly, the distributed nodes IAB-1˜IAB-3 and UEs UE2˜UE3 may measure the measurement data in the same way. Afterwards, the distributed nodes IAB-1˜IAB-3 and the UEs UE1˜UE3 may send the measurement data to the centralized management node IAB-donor.

In one embodiment, after step S511, the centralized management node IAB-donor may determine whether the PDB information corresponding to at least one of the plurality of communication channels is required to be created or modified according to the measurement data, so as to assign the PDB information per hop to the distributed node if the PDB information is required to be created or modified.

Then, in step S512, the distributed nodes IAB-1˜IAB-3 receive the PDB information assigned by the centralized management node IAB-donor. In detail, the centralized management node IAB-donor may decide the PDB information per hop according to PDB sums of the DRB of the at least one UE (i.e. the UEs UE1˜UE3), and send the PDB information per hop to each of the distributed nodes IAB-1˜IAB-3.

In one embodiment, after receiving the PDB information in step S512, the distributed nodes IAB-1˜IAB-3 may determine whether at least one communication channel is required to be created or modified according to the PDB information and modify at least one existing communication channel or creating at least one new communication channel according to the PDB information if at least one communication channel is required to be created or modified.

For example, in case that all of the distributed nodes IAB-1˜IAB-3 have stored information about three communication channels, wherein the PDB value of first communication channel is 5, the PDB value of second communication channel is 10, and the PDB value of third communication channel is 15, the distributed node IAB-1 may determine whether the first communication channel can match the DRB of the UE UE1 between the distributed node IAB-1 and the UE UE1, whether the second communication channel can match the DRB of the UE UE2 between the distributed nodes IAB-1 and IAB-2, and whether the third communication channel can match the DRB of the UE UE3 between the distributed nodes IAB-1 and IAB-2. The distributed node IAB-2 may determine whether the first communication can match the DRB of the UE UE2 between the distributed node IAB-2 and the UE UE2, and whether the second communication channel may match the DRB of the UE UE3 between the distributed nodes IAB-2 and IAB-3. The distributed node IAB-3 may determine whether the second communication channel may match the DRB of the UE UE3 between the distributed nodes IAB-3 and the UE UE3. Therefore, the distributed nodes IAB-1˜IAB-3 do not need to create or modify any communication channel.

Further, if the PDB value of the DRB of the UE UE1 between the centralized management node IAB-donor and the distributed node IAB-1 is changed to 2 and the PDB value of the DRB of the UE UE1 between the distributed nodes IAB-1 and IAB-2 is changed to 8, the distributed node IAB-1 may create a fourth communication channel and a fifth communication channel, wherein the PDB value of fourth communication channel is 2, and the PDB value of fifth communication channel is 8.

Finally, in step S513, the distributed nodes IAB-1˜IAB-3 decide a bearer mapping between a DRB of at least one UE and the plurality of communication channels to serve the at least one UE. In detail, the distributed node IAB-1 may decide bearer mapping corresponding to each node subsidiary to the distributed node IAB-1, the distributed node IAB-2 may decide bearer mapping corresponding to each node subsidiary to the distributed node IAB-2, and the distributed node IAB-3 may decide bearer mapping corresponding to each node subsidiary to the distributed node IAB-3.

For example, based on the example in step S512, the distributed node IAB-1 may map the first communication channel to the DRB of the UE UE1 between the distributed node IAB-1 and the UE UE1, map the second communication channel to the DRB of the UE UE2 between the distributed nodes IAB-1 and IAB-2, and map the third communication channel to the DRB of the UE UE3 between the distributed nodes IAB-1 and IAB-2. The distributed node IAB-2 may map the first communication to the DRB of the UE UE2 between the distributed node IAB-2 and the UE UE2, and map the second communication channel to the DRB of the UE UE3 between the distributed nodes IAB-2 and IAB-3. The distributed node IAB-3 may map the second communication channel to the DRB of the UE UE3 between the distributed nodes IAB-3 and UE UE3.

It is noted that, in some embodiments, an order of the step S512 and step S513 may be exchanged, but the embodiment is not limited thereto.

Based on the above, the centralized management node IAB-donor may decide the PDB information corresponding to each node according to the measurement data, and the distributed nodes IAB-1˜IAB-2 may decide its bearer mapping according to the PDB information and existing communication channels corresponding to each node. Similarly, scheduling implementation of PDB for general single-hop environment may be reused in multi-hop IAB network.

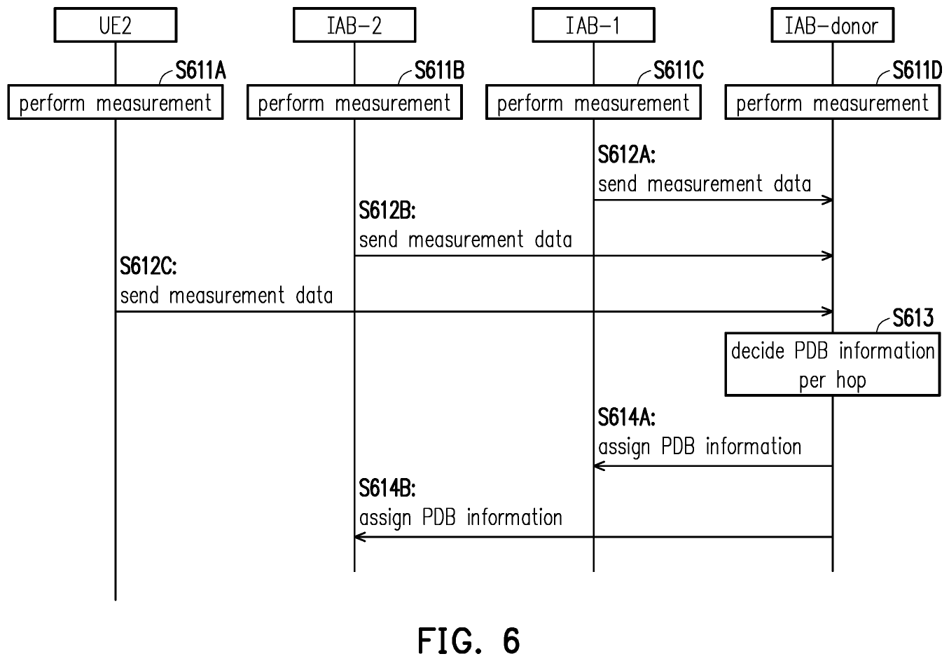

FIG. 6 is schematic diagrams illustrating a packet delay control method according to an embodiment of the disclosure. Detailed steps of the method are described below with reference to the centralized management IAB-donor, the distributed nodes IAB-1˜IAB-2 and the UE UE2 of FIG. 1. The following takes the DRB of the UE2 as an example.

In the embodiments of FIG. 6, the steps of the packet delay control method include:

Steps S611A˜S611D: the centralized management IAB-donor, the distributed nodes IAB-1˜IAB-2 and the UE UE2 perform measurement, respectively. In one embodiment, the centralized management IAB-donor may detect its congestion level and downlink delays of communication channels between the centralized management IAB-donor and the distributed node IAB-1. The distributed node IAB-1 may detect its congestion level, downlink delays of communication channels between the distributed nodes IAB-1 and IAB-2, and uplink delays of communication channels between the centralized management IAB-donor and the distributed node IAB-1. The distributed node IAB-2 may detect its congestion level, downlink delays of communication channels between the distributed node IAB-2 and the UE UE2, and uplink delays of communication channels between the distributed nodes IAB-1 and IAB-2. The UE UE2 may detect an uplink delay of a communication channel between the distributed node IAB-2 and the UE UE2.

Steps S612A˜S612C: the distributed nodes IAB-1˜IAB-2 and the UE UE2 send measurement data to the centralized management IAB-donor respectively. In one embodiment, measurement data may include the congestion level of the distributed node IAB-1, the downlink delays of the communication channels between the distributed nodes IAB-1 and IAB-2, the uplink delays of the communication channels between the centralized management IAB-donor and the distributed node IAB-1, the congestion level of the distributed node IAB-2, the downlink delays of the communication channels between the distributed node IAB-2 and the UE UE2, the uplink delays of the communication channels between the distributed node IAB-1 and IAB-2, and the uplink delay of the communication channel between the distributed node IAB-2 and the UE UE2.

Step S613: the centralized management IAB-donor decides PDB information per hop.

Steps S614A˜S614B: the centralized management IAB-donor assigns the PDB information to the distributed nodes IAB-1˜IAB-2, respectively, such that the distributed nodes IAB-1˜IAB-2 may decide a bearer mapping between a DRB of the UE UE2 and the communication channels to serve the UE UE2.

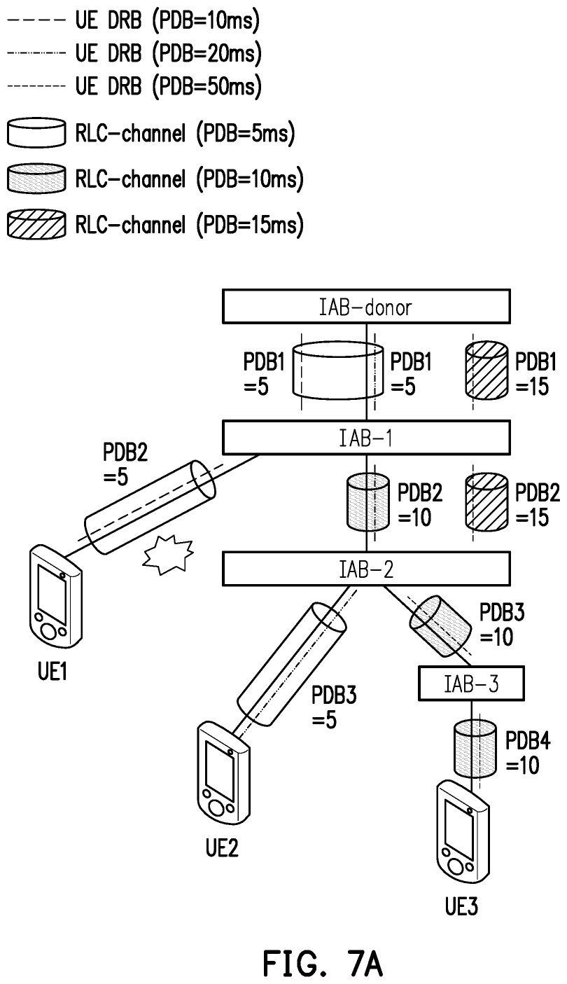

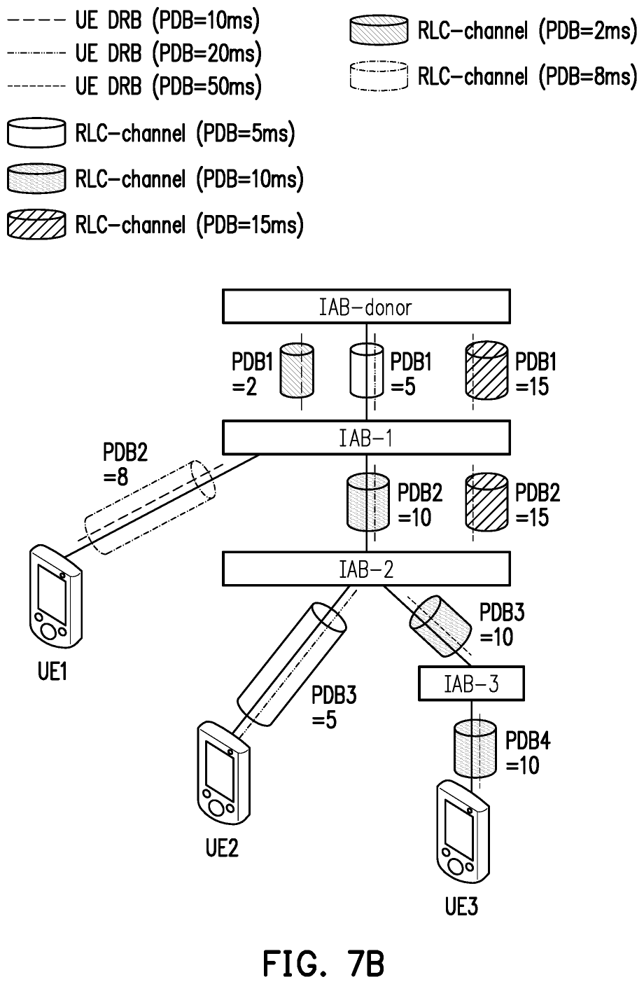

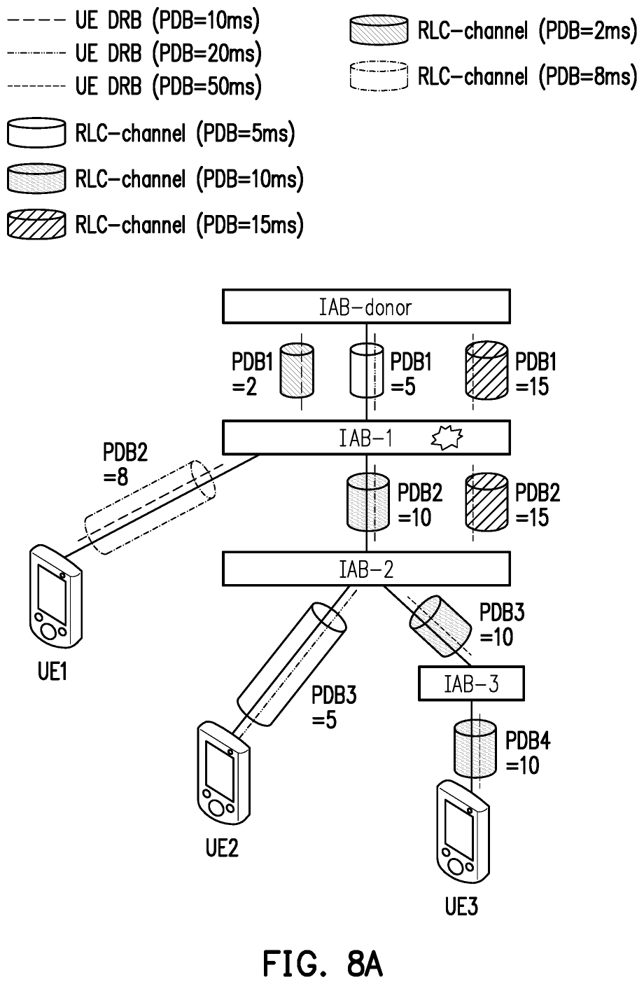

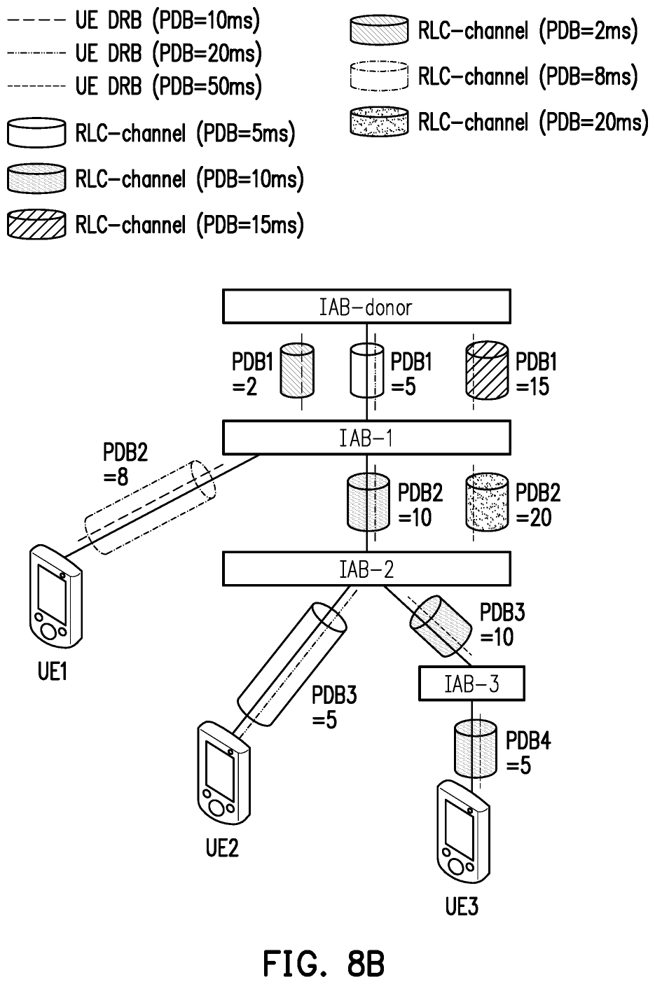

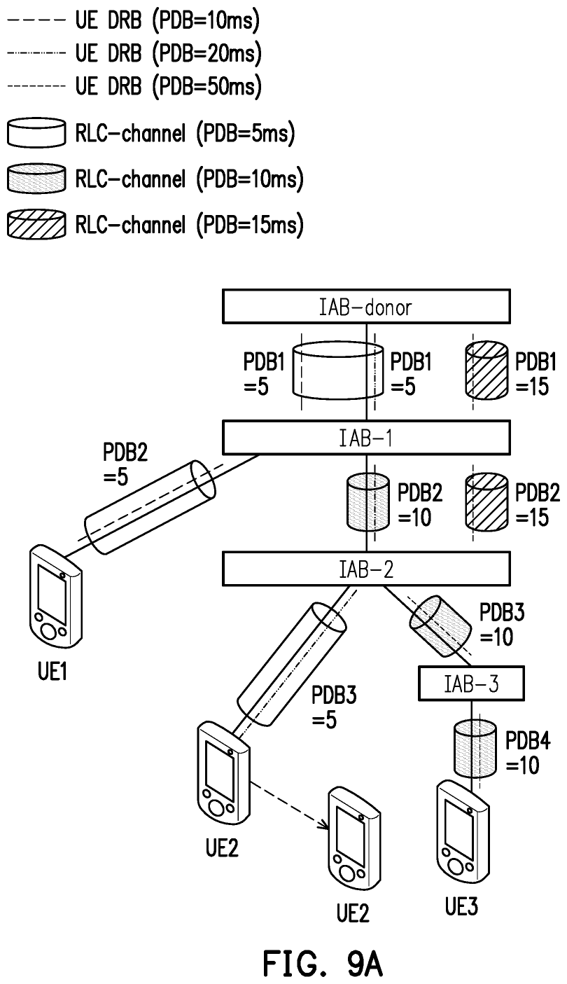

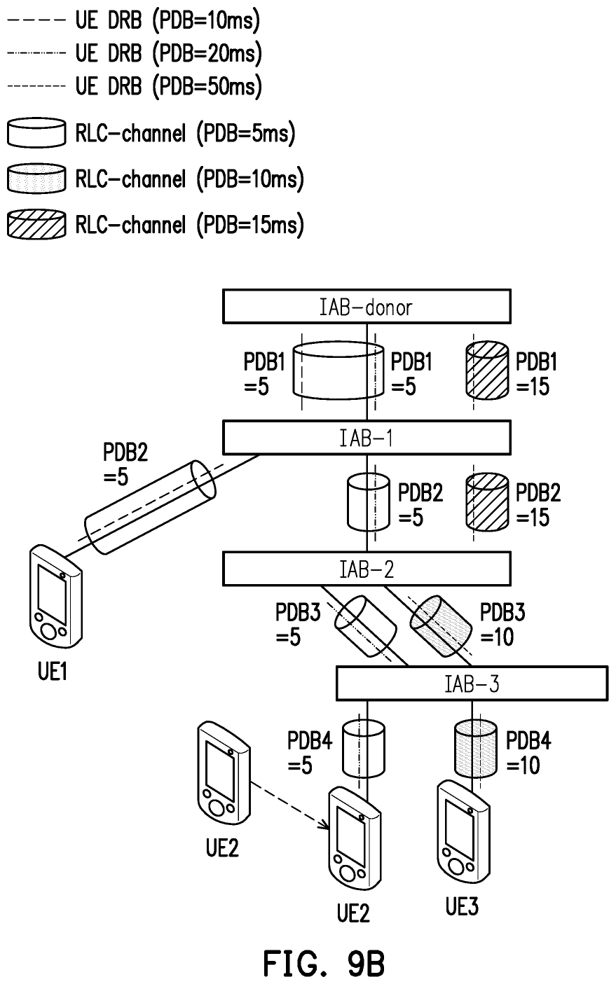

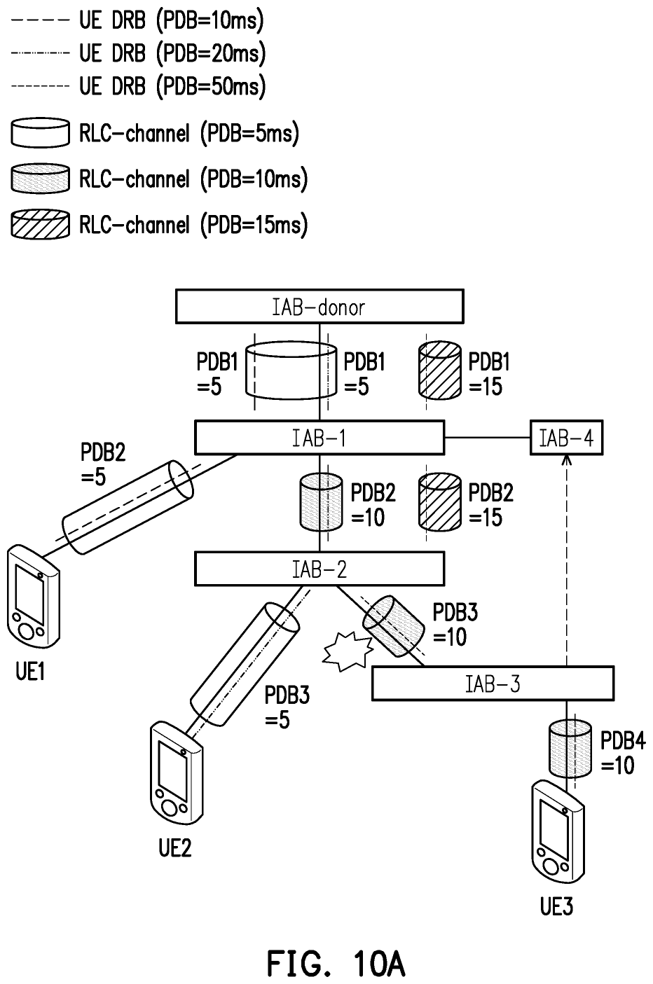

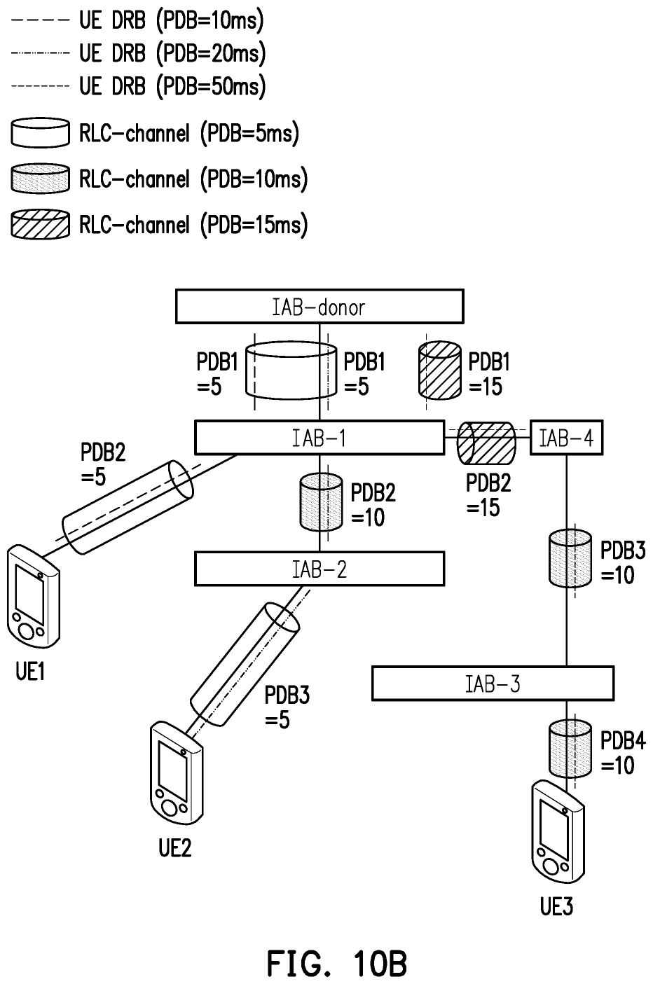

FIG. 7A and FIG. 7B, FIG. 8A and FIG. 8B, FIG. 9A and FIG. 9B, and FIG. 10A and FIG. 10B are schematic diagrams of examples of modifying bearer mapping in a wireless multi-hop network system according to an embodiment of the disclosure. Referring to FIG. 7A and FIG. 7B, the wireless multi-hop network system of the present example includes, for example, a centralized management node IAB-donor, distributed nodes IAB-1˜IAB-3 and UEs UE1˜UE3.

The centralized management node IAB-donor has mapped a first RLC-channel (PDB=5 ms) to the DRB of the UE UE1 between the centralized management node IAB-donor and the distributed node IAB-1 (PDB1=5 ms), the DRB of the UE UE2 between the centralized management node IAB-donor and the distributed node IAB-1 (PDB1=5 ms), and has mapped a third RLC-channel (PDB=15 ms) to the DRB of the UE UE3 between the centralized management node IAB-donor and the distributed node IAB-1 (PDB1=15). The centralized management node IAB-donor or the distributed node IAB-1 has mapped a first RLC-channel (PDB=5 ms) to the DRB of the UE UE1 between the distributed node IAB-1 and the UE UE1 (PDB2=5 ms), has mapped a second RLC-channel (PDB=10 ms) to the DRB of the UE UE2 between the distributed nodes IAB-1 and IAB-2 (PDB2=10 ms), and has mapped a third RLC-channel (PDB=15 ms) to the DRB of the UE UE3 between the distributed nodes IAB-1 and IAB-2 (PDB2=15 ms). The centralized management node IAB-donor or the distributed node IAB-2 has mapped the first RLC-channel to the DRB of the UE UE2 between the distributed node IAB-2 and the UE UE2 (PDB3=5 ms), and has mapped the second RLC-channel to the DRB of the UE UE3 between the distributed nodes IAB-2 and IAB-3 (PDB3=10 ms). The centralized management node IAB-donor or the distributed node IAB-3 has mapped the second RLC-channel to the DRB of the UE UE3 between the distributed node IAB-3 and the UE UE3 (PDB4=10 ms).

When the centralized management node IAB-donor detects a link congestion (i.e. a congestion level is “high”) between the distributed node IAB-1 and the UE UE1 according to the measurement data, the centralized management node IAB-donor determines that the PDB2 of UE UE1 between the distributed node IAB-1 and the UE UE1 is required to be increased from 5 to 8 and the PDB1 of UE UE1 between the centralized management node IAB-donor and the distributed node IAB-1 is required to be decreased from 5 to 2. Therefore, the distributed node IAB-1 or the centralized management node IAB-donor needs to create two channels with PDB values of 2 and 8, respectively. And then, the distributed node IAB-1 or the centralized management node IAB-donor will match two channels to the DRB of the UE UE1 between the distributed node IAB-1 and the UE UE1 and the DRB of the UE UE1 between the centralized management node IAB-donor and the distributed node IAB-1, respectively.

Referring to FIGS. 8A and 8B, the wireless multi-hop network system of the present example includes, for example, a centralized management node IAB-donor, distributed nodes IAB-1˜IAB-3 and UEs UE1˜UE3.

The centralized management node IAB-donor has mapped a first RLC-channel (PDB=5 ms) to the DRB of the UE UE2 between the centralized management node IAB-donor and the distributed node IAB-1 (PDB1=5 ms), has mapped a third RLC-channel (PDB=15 ms) to the DRB of the UE UE3 between the centralized management node IAB-donor and the distributed node IAB-1 (PDB1=15 ms), and has mapped a fourth RLC-channel (PDB=2 ms) to the DRB of the UE UE1 between the centralized management node IAB-donor and the distributed node IAB-1 (PDB1=2 ms). The centralized management node IAB-donor or the distributed node IAB-1 has mapped a second RLC-channel (PDB=10 ms) to the DRB of the UE UE2 between the distributed nodes IAB-1 and IAB-2 (PDB2=10 ms), has mapped a third RLC-channel (PDB=15 ms) to the DRB of the UE UE3 between the distributed nodes IAB-1 and IAB-2 (PDB2=15 ms), and has mapped a fifth RLC-channel (PDB=8 ms) to the DRB of the UE UE1 between the distributed node IAB-1 and the UE UE1 (PDB2=8 ms). The centralized management node IAB-donor or the distributed node IAB-2 has mapped the first RLC-channel to the DRB of the UE UE2 between the distributed node IAB-2 and the UE UE2 (PDB3=5 ms), and has mapped the second RLC-channel to the DRB of the UE UE3 between the distributed nodes IAB-2 and IAB-3 (PDB3=10 ms). The centralized management node IAB-donor or the distributed node IAB-3 has mapped the second RLC-channel to the DRB of the UE UE3 between the distributed node IAB-3 and the UE UE3 (PDB4=10 ms).

When the centralized management node IAB-donor detects a node congestion (i.e. a congestion level is “high”) of the distributed node IAB-1 according to the measurement data, the centralized management node IAB-donor determines that the PDB2 of the UE UE3 between the distributed node IAB-1 and the distributed node IAB-2 is required to be increased from 15 to 20 and the PDB4 of the UE UE3 between the distributed node IAB-3 and the UE UE3 is required to be decreased from 10 to 5. Therefore, the distributed node IAB-1 or the centralized management node IAB-donor is required to create a RLC-channel with a PDB value of 20 and another RLC-channel with a PDB value of 5. And then, the distributed node IAB-1 or the centralized management node IAB-donor will match the channel to the DRB of the UE UE3 between the distributed nodes IAB-1 and IAB-2, and the distributed node IAB-3 or the centralized management node IAB-donor will match the channel to the DRB of the UE UE3 between the distributed node IAB-3 and the UE UE3, respectively.

Referring to FIGS. 9A and 9B, the wireless multi-hop network system of the present example includes, for example, a centralized management node IAB-donor, distributed nodes IAB-1˜IAB-3 and UEs UE1˜UE3.

The centralized management node IAB-donor has mapped a first RLC-channel (PDB=5 ms) to the DRB of the UE UE1 between the centralized management node IAB-donor and the distributed node IAB-1 (PDB1=5 ms), the DRB of the UE UE2 between the centralized management node IAB-donor and the distributed node IAB-1 (PDB1=5 ms), and has mapped a third RLC-channel (PDB=15 ms) to the DRB of the UE UE3 between the centralized management node IAB-donor and the distributed node IAB-1 (PDB1=15). The centralized management node IAB-donor or the distributed node IAB-1 has mapped a first RLC-channel (PDB=5 ms) to the DRB of the UE UE1 between the distributed node IAB-1 and the UE UE1 (PDB2=5 ms), has mapped a second RLC-channel (PDB=10 ms) to the DRB of the UE UE2 between the distributed nodes IAB-1 and IAB-2 (PDB2=10 ms), and has mapped a third RLC-channel (PDB=15 ms) to the DRB of the UE UE3 between the distributed nodes IAB-1 and IAB-2 (PDB2=15 ms). The centralized management node IAB-donor or the distributed node IAB-2 has mapped the first RLC-channel to the DRB of the UE UE2 between the distributed node IAB-2 and the UE UE2 (PDB3=5 ms), and has mapped the second RLC-channel to the DRB of the UE UE3 between the distributed nodes IAB-2 and IAB-3 (PDB3=10 ms). The centralized management node IAB-donor or the distributed node IAB-3 has mapped the second RLC-channel to the DRB of the UE UE3 between the distributed node IAB-3 and the UE UE3 (PDB3=10 ms).

When the centralized management node IAB-donor detects that an uplink delay of the UE UE2 and a downlink delay of the distributed node IAB-2 are respectively larger than default thresholds (e.g. the UE UE2 move to a position nearby the distributed node IAB-3), the centralized management node IAB-donor may determine that handover for the UE UE2 from the distributed node IAB-2 to another node nearby the UE UE2 (i.e. the distributed node IAB-3) is required. Accordingly, the centralized management node IAB-donor may modify the RLC-channel between the distributed nodes IAB-1 and IAB-2 with the PDB values changed from 10 to 5 (PDB2=5 ms), create a RLC-channel between the distributed nodes IAB-2 and IAB-3 with the PDB values of 5 (PDB3=5 ms), and create a RLC-channel between the distributed node IAB-3 and the UE UE2 with the PDB values of 5 (PDB4=5 ms).

Referring to FIGS. 10A and 10B, the wireless multi-hop network system of the present example includes, for example, a centralized management node IAB-donor, distributed nodes IAB-1˜IAB-4 and UEs UE1˜UE3.

The centralized management node IAB-donor has mapped a first RLC-channel (PDB=5 ms) to the DRB of the UE UE1 between the centralized management node IAB-donor and the distributed node IAB-1 (PDB1=5 ms), the DRB of the UE UE2 between the centralized management node IAB-donor and the distributed node IAB-1 (PDB1=5 ms), and has mapped a third RLC-channel (PDB=15 ms) to the DRB of the UE UE3 between the centralized management node IAB-donor and the distributed node IAB-1 (PDB1=15). The centralized management node IAB-donor or the distributed node IAB-1 has mapped a first RLC-channel (PDB=5 ms) to the DRB of the UE UE1 between the distributed node IAB-1 and the UE UE1 (PDB2=5 ms), has mapped a second RLC-channel (PDB=10 ms) to the DRB of the UE UE2 between the distributed nodes IAB-1 and IAB-2 (PDB2=10 ms), and has mapped a third RLC-channel (PDB=15 ms) to the DRB of the UE UE3 between the distributed nodes IAB-1 and IAB-2 (PDB2=15 ms). The centralized management node IAB-donor or the distributed node IAB-2 has mapped the first RLC-channel to the DRB of the UE UE2 between the distributed node IAB-2 and the UE UE2 (PDB3=5 ms), and has mapped the second RLC-channel to the DRB of the UE UE3 between the distributed nodes IAB-2 and IAB-3 (PDB3=10 ms). The centralized management node IAB-donor or the distributed node IAB-3 has mapped the second RLC-channel to the DRB of the UE UE3 between the distributed node IAB-3 and the UE UE3 (PDB4=10 ms).

When the centralized management node IAB-donor detects a link congestion (i.e. congestion level is “high”) between the distributed nodes IAB-2 and IAB-3 according to the measurement data, the centralized management node IAB-donor determines that handover for the distributed node IAB-3 from the distributed node IAB-2 to the distributed node IAB-4 is required. Accordingly, the centralized management node IAB-donor may create a RLC-channel between the distributed nodes IAB-1 and IAB-4 with the PDB values of 15 (PDB2=15 ms) and create a RLC-channel between the distributed nodes IAB-4 and IAB-3 with the PDB values of 10 (PDB3=10 ms).

Based on the above, in the embodiments of the present disclosure, the centralized management node may decide the PDB information and the bearer mapping for each node according to the measurement data from the corresponding nodes, or the distributed node may decide its bearer mapping according to the PDB information assigned by the centralized management node. For applications with strict delay budget (e.g. voice), mechanisms adapted to either single-hop or multiple-hop environment are provided to ensure that the packet delay budget is met across the IAB network and the topology adaption may be triggered. Accordingly, scheduling implementation of PDB for general single-hop environment may be reused in multi-hop IAB network.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A packet delay control method, for a centralized management node, comprising:
receiving measurement data related to packet delay for each of a plurality of first communication channels from at least one node subsidiary to the centralized management node; and
assigning a packet delay budget (PDB) information to a data radio bearer (DRB) per hop of at least one user equipment (UE).

2. The method according to claim 1, wherein after the step of receiving measurement data related to packet delay for each of the plurality of first communication channels from the at least one node subsidiary to the centralized management node, the method further comprises:
determining whether the PDB information corresponding to at least one of the plurality of first communication channels is required to be created or modified according to the measurement data.

3. The method according to claim 1, wherein the step of assigning the PDB information per hop to the DRB of the at least one UE comprises:
determining the PDB information per hop according to PDB sums of the DRB of the at least one UE.

4. The method according to claim 1, comprising:
assigning a bearer mapping between the DRB of the at least one UE and a plurality of second communication channels along with the DRB of the at least one UE to serve the at least one UE.

5. The method according to claim 4, wherein the step of assigning the bearer mapping between the DRB of the at least one UE and the plurality of second communication channels along with the DRB of the at least one UE to serve the at least one UE comprises:
selecting at least one communication channel from a plurality of existing third communication channels according to the PDB information; or
creating at least one new communication channel according to the PDB information.

6. The method according to claim 1, wherein the measurement data is measured by each of the at least one node or the at least one UE periodically detecting at least one of an uplink communication channel and a downlink communication channel between the node and the UE subsidiary to the node.

7. The method according to claim 1, wherein the measurement data is measured by each of the at least one node or the at least one UE detecting at least one of an uplink communication channel and a downlink communication channel between the node and the UE subsidiary to the node when the UE or the node is congested, the uplink communication channel of the UE is congested, or the uplink communication channel or the downlink communication channel of the node is congested.

8. The method according to claim 1, wherein the measurement data comprises one or a combination of congestion level information, uplink delay information and downlink delay information corresponding to the plurality of communication channels, wherein the plurality of communication channels are radio link control (RLC) channels.

9. A packet delay control method, for a distributed node, comprising:
measuring measurement data related to packet delay for each of a plurality of first communication channels and reporting the measurement data to a centralized management node; and
receiving a packet delay budget (PDB) information assigned by the centralized management node.

10. The method according to claim 9, wherein after the step of reporting the measurement data to the centralized management node, the method further comprises:
the centralized management node determining whether the PDB information corresponding to at least one of the plurality of first communication channels is required to be created or modified according to the measurement data, and assigning the PDB information to the distributed node if the PDB information is required to be created or modified.

11. The method according to claim 9, comprising:
receiving a bearer mapping between a data radio bearer (DRB) of at least one user equipment (UE) and a plurality of second communication channels along with the DRB of the at least one UE to serve the at least one UE.

12. The method according to claim 9, wherein after the step of receiving the PDB information assigned by the centralized management node, the method further comprises:
modifying at least one existing third communication channel or creating at least one new communication channel according to the PDB information if at least one communication channel is required to be created or modified according to the PDB information.

13. The method according to claim 9, wherein the measurement data is measured by the distributed node or an UE subsidiary to the distributed node periodically detecting at least one of an uplink communication channel and a downlink communication channel between the distributed node and the UE.

14. The method according to claim 9, wherein the measurement data is measured by the distributed node or an UE subsidiary to the distributed node detecting at least one of an uplink communication channel and a downlink communication channel between the distributed node and the UE when the UE or the node is congested, the uplink communication channel of the UE is congested, or the uplink communication channel or the downlink communication channel of the node is congested.

15. The method according to claim 9, wherein the measurement data comprises one or a combination of congestion level information, uplink delay information and downlink delay information corresponding to the plurality of communication channels, wherein the plurality of communication channels are radio link control (RLC) channels.

16. A centralized management node, comprising:
a communication interface, communicating with at least one node subsidiary to the centralized management node; and
a processor, coupled to the communication interface and configured to execute instructions to:
receive measurement data related to packet delay for each of a plurality of first communication channels from the at least one node subsidiary to the centralized management node;
assign a packet delay budget (PDB) information to a data radio bearer (DRB) per hop of at least one user equipment (UE).

17. The centralized management node according to claim 16, wherein the processor determines whether the PDB information corresponding to at least one of the plurality of first communication channels is required to be created or modified according to the measurement data.

18. The centralized management node according to claim 16, wherein the processor determines the PDB information per hop according to PDB sums of the DRB of the at least one UE.

19. The centralized management node according to claim 16, wherein the processor assigns a bearer mapping between the DRB of the at least one UE and a plurality of second communication channels along with the DRB of the at least one UE to serve the at least one UE.

20. The centralized management node according to claim 16, wherein the processor selects at least one communication channel for each node from a plurality of existing third communication channels or creates a plurality of new communication channel according to the PDB information.

21. A distributed node, comprising:
a communication interface, communicating with a centralized management node; and
a processor, coupled to the communication interface and configured to execute instructions to:
measure measurement data related to packet delay for each of a plurality of first communication channels and reporting the measurement data to a centralized management node;
receive a packet delay budget (PDB) information assigned by the centralized management node.

22. The distributed node according to claim 21, wherein the centralized management node determines whether the PDB information corresponding to at least one of the plurality of first communication channels is required to be created or modified according to the measurement data, and assigns the PDB information per hop to the distributed node if the PDB information is required to be created or modified.

23. The distributed node according to claim 21, wherein the processor receives a bearer mapping between a data radio bearer (DRB) of at least one user equipment (UE) and a plurality of second communication channels along with the DRB of the at least one UE to serve the at least one UE.

24. The distributed node according to claim 21, wherein the processor modifies at least one existing third communication channel or creates at least one new communication channel according to the PDB information if at least one communication channel is required to be created or modified according to the PDB information.
